(19) United States
(12) Patent Application Publication
(10) Pub. No.: US 2025/0141014 A1
(43) Pub. Date: May 1, 2025

(54) LITHIUM BATTERY PACK FOR WHEELCHAIR AND MEDICAL AUXILIARY DRIVING EQUIPMENT

(71) Applicant: MPS KOREA CO., LTD., Gyeonggi-do (KR)

(72) Inventor: Yang Ki Il, Gyeonggi-do (KR)

(73) Assignee: MPS KOREA CO., LTD., Gyeonggi-do (KR)

(21) Appl. No.: 18/622,098

(22) Filed: Mar. 29, 2024

(30) Foreign Application Priority Data
Oct. 25, 2023 (KR) 10-2023-0143777

(51) Int. Cl. H01M 50/249; H01M 10/052; H01M 10/42; H01M 10/46; H01M 10/613; H01M 10/625; H01M 10/643; H01M 10/6551; H01M 10/6562; H01M 50/213; H01M 50/224; H01M 50/256; H01M 50/267; H01M 50/271; H01M 50/296; H01M 50/298; H02J 7/00

(52) U.S. Cl. CPC H01M 50/249; H01M 10/052; H01M 10/425; H01M 10/46; H01M 10/613; H01M 10/625; H01M 10/643; H01M 10/6551; H01M 10/6562; H01M 50/213; H01M 50/224; H01M 50/256; H01M 50/267; H01M 50/271; H01M 50/296; H01M 50/298; H01M 2220/20; H02J 7/0042

(57) ABSTRACT

The present invention is intended to provide a lithium battery pack for a wheelchair and medical auxiliary driving equipment, the lithium battery pack including a battery module configured such that a plurality of cylindrical batteries are arranged along the horizontal and vertical directions therein, an insulation case configured to cover the battery module in an insulating manner while fastening the battery module, and a battery case injection-molded with aluminum so that it has excellent heat dissipation performance, wherein the insulation case covering the battery module is allowed to be detachably inserted and fastened into the battery case, so that the lithium battery pack can be easily mounted on various types of auxiliary driving equipment such as a medical electric scooter, a medical electric wheelchair, etc.

### CROSS-REFERENCE TO RELATED APPLICATION

This application claims the benefit of Korean Patent Application No. 10-2023-0143777 filed on Oct. 25, 2023, which is hereby incorporated by reference herein in its entirety.

### BACKGROUND

### 1. Technical Field

The present invention relates generally to a lithium battery pack for a wheelchair and medical auxiliary driving equipment, and more particularly to a lithium battery pack for a wheelchair and medical auxiliary driving equipment that can be easily used in various types of medical auxiliary driving equipment such as a medical electric scooter, a medical electric wheelchair, etc.

### 2. Description of the Related Art

In general, secondary batteries are batteries which can be charged with electricity and from which electricity is discharged. In the case of batteries for the drive motors of electric vehicles, high-capacity secondary batteries that are modularized by connecting multiple battery cells in series or parallel are used.

As secondary batteries are each manufactured in a modularized structure in which a plurality of battery cells are stacked and stored in a case and the individual battery cells are electrically connected to one another, overcharging, overdischarging, overcurrent, heat generation, and/or the like may occur.

Accordingly, a cooling device configured to cool the battery cells needs to be installed inside and outside the case.

Cooling methods for batteries for electric vehicles currently in use can be basically classified into air cooling and water cooling.

The water cooling method is a method of installing a heat sink, etc. in a battery case and circulating coolant toward the heat sink. In this case, a plurality of battery cells can be cooled by the heat sink that is cooled by the coolant.

The conventional water cooling device can increase the efficiency of the cooling of battery cells by easily installing a heat sink or a coolant circulation tube in a state where square or pouch-shaped battery cells are stacked. However, when a plurality of cylindrical batteries are stacked, it is difficult to apply the water cooling device and also it is difficult to evenly cool the plurality of cylindrical batteries. In particular, it is inconvenient to carry the water cooling device because it needs to be connected to a coolant supply source.

### SUMMARY

The present invention has been conceived to overcome the above-described problems, and an object of the present invention is to provide a lithium battery pack for a wheelchair and medical auxiliary driving equipment, the lithium battery pack including a battery module configured such that a plurality of cylindrical batteries are arranged along the horizontal and vertical directions therein, an insulation case configured to cover the battery module in an insulating manner while fastening the battery module, and a battery case injection-molded with aluminum so that it has excellent heat dissipation performance, wherein the insulation case covering the battery module is allowed to be detachably inserted and fastened into the battery case, so that the lithium battery pack can be easily mounted on various types of auxiliary driving equipment such as a medical electric scooter, a medical electric wheelchair, etc.

In order to accomplish the above object, the present invention provides a lithium battery pack for a wheelchair and medical auxiliary driving equipment, the lithium battery pack including: a battery module configured such that a plurality of cylindrical batteries are arranged along the horizontal and vertical directions therein; an insulation case fastened to the top, bottom, and peripheral portions of the battery module in an insulating manner; a battery case injection-molded with aluminum so that the battery module and the insulation case fastened to the battery module can be detachably inserted and fastened thereinto; a front cover mounted on the front of the battery case in the state in which the battery module and the insulation case are inserted and fastened into the battery case; and a connector mounted at a predetermined position on the front cover to charge and discharge the battery module.

The battery module may include a plurality of battery trays provided with a plurality of battery insertion portions, and a plurality of cylindrical batteries configured to be inserted and fastened into the battery insertion portions of the individual battery trays; in the state in which the battery module is inserted and fastened into the battery case, the individual cylindrical batteries inserted into the battery insertion portions of the individual battery trays may be spaced apart from each other while forming air passages; and cooling fins may be disposed in close contact between the individual cylindrical batteries, and cooling tubes each having an air passage may be inserted to pass through the cooling fins.

One or more air inlet holes configured to allow air to flow into the air passages may be formed at predetermined positions in the battery case.

The insulation case may include: an upper plate provided in a structure in which a plurality of upper heat dissipation holes for communicating between the upper plate portion of the battery case and the battery module are formed therethrough, and configured to come into close contact with the top of the battery module; a lower plate provided in a structure in which a plurality of lower heat dissipation holes for communicating between the lower plate portion of the battery case and the battery module are formed therethrough, and configured to come into close contact with the bottom of the battery module; and vertical connection bars connected between the four corner positions of the upper plate and the four corner positions of the lower plate.

Right-angled stepped blocks configured to accommodate and support battery modules having different sizes may protrude at four corner positions on the top surface of the upper plate and four corner positions on the bottom surface of the lower plate, so that the four corners of the battery module are each supported in close contact with one side or the other side of each of the stepped blocks.

Two or more rail portions formed to be concave inward may be formed on the upper and lower plate portions of the battery case, and slide protrusions each configured to come into close slidable contact with one side of each of the rail portions may be formed on the upper and lower plates of the insulation case.

A plurality of heat dissipation fins may protrude from the inner surfaces of the upper and lower plates of the battery case, and slide protrusions configured to be slidably coupled to or come into close slidable contact with the heat dissipation fins may be formed on the upper and lower plates of the insulation case.

The front cover may be mounted with a handle used for carrying.

The lithium battery pack may further include: a bus bar mounted in a front space of the battery case while being conductively connected to the battery module; and a battery control board conductively connected to the bus bar, and configured to control the discharging of battery power to the connector or control charging of charging power, coming from the connector, into the battery module.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing the appearance of a lithium battery pack for a wheelchair and medical auxiliary driving equipment according to the present invention;

FIG. 2 is an exploded perspective view showing the configuration of the lithium battery pack for a wheelchair and medical auxiliary driving equipment according to the present invention;

FIGS. 3 and 4 are partial enlarged perspective views showing battery modules having different sizes that are each installed in the insulation case of the lithium battery pack for a wheelchair and medical auxiliary driving equipment according to the present invention;

FIGS. 5 and 6 are sectional plan views showing the battery modules having different sizes that are each installed in the insulation case of the lithium battery pack for a wheelchair and medical auxiliary driving equipment according to the present invention;

FIGS. 7 and 8 are sectional views showing a structure in which the battery case and insulation case of the lithium battery pack for a wheelchair and medical auxiliary driving equipment according to the present invention are coupled to each other;

FIG. 9 is a sectional plan view showing the air cooling of the battery module of the lithium battery pack for a wheelchair and medical auxiliary driving equipment according to the present invention are coupled to each other;

FIG. 10 is an exploded perspective view showing only one battery module of the lithium battery pack for a wheelchair and medical auxiliary driving equipment according to the present invention are coupled to each other; and

FIG. 11 is a partially enlarged perspective view showing a structure in which cylindrical batteries of the lithium battery pack for a wheelchair and medical auxiliary driving equipment according to the present invention are coupled to each other are air-cooled.

### DETAILED DESCRIPTION

Embodiments of the present invention will be described in detail below with reference to the accompanying drawings.

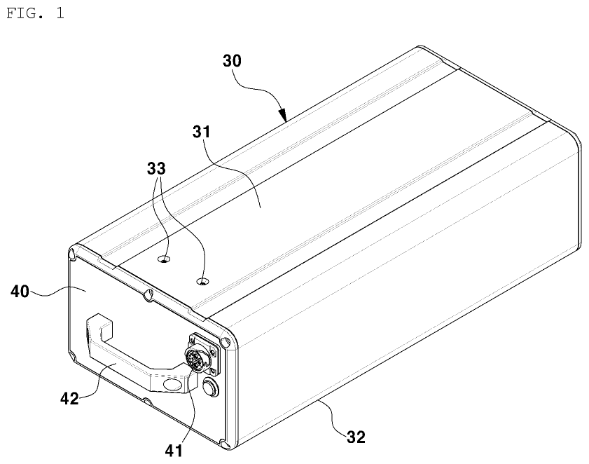

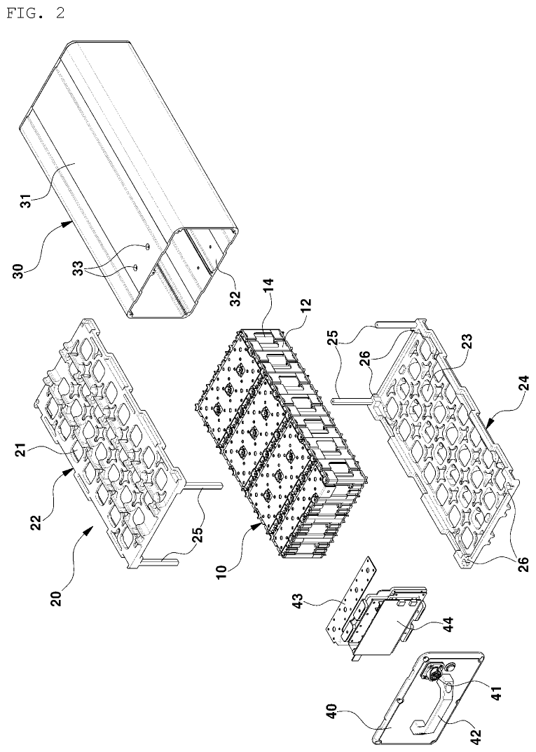

The accompanying FIGS. 1 and 2 are perspective views showing a lithium battery pack for a wheelchair and medical auxiliary driving equipment according to the present invention, and reference numeral 30 denotes a battery case.

The battery case 30 is formed in a rectangular structure having an internal volume for accommodating a battery module 10 and an insulation case 20. In particular, the battery case 30 is injection-molded with an aluminum material having excellent thermal conductivity in order to easily dissipate heat, generated from the battery module 10, to the outside.

The battery module 10 is inserted and fastened inside the battery case 30 while being surrounded by the insulation case 20.

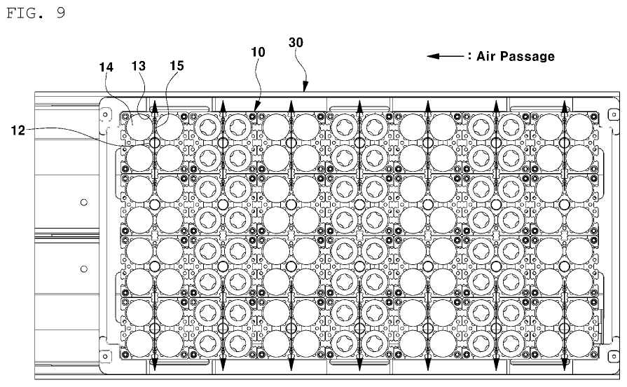

To this end, as can be clearly seen in FIG. 9, the battery module 10 includes a plurality of battery trays 14 provided with a plurality of battery insertion portions 13, and a plurality of cylindrical batteries 12 configured to be inserted and fastened into the battery insertion portions 13 of the individual battery trays 14.

In this case, in the state in which the battery module 10 is inserted and fastened into the battery case 30, the individual cylindrical batteries 12 inserted into the battery insertion portions 13 of the individual battery trays 14 may be spaced apart from each other while forming air passages 15.

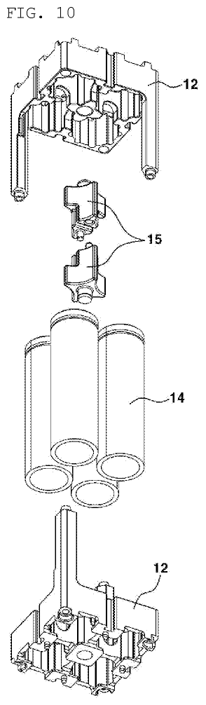

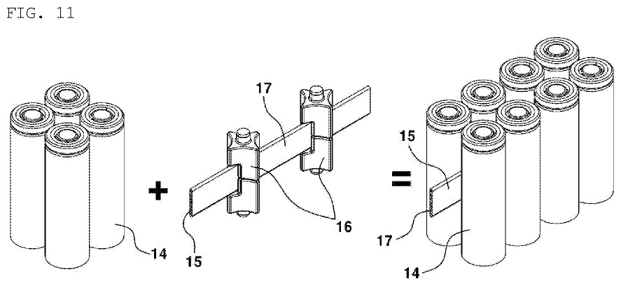

More specifically, as shown in FIGS. 10 and 11, when the cylindrical batteries 12 are inserted into the battery trays 14, they are inserted such that cooling fins 16 are placed in close contact between the individual cylindrical batteries 12, and cooling tubes 17 each having an air passage 15 pass through the cooling fins 16.

Preferably, air inlet holes 33 configured to allow air to flow into the air passages 15 are formed at predetermined positions of the battery case 30.

Accordingly, the air introduced into the inside of the battery case 30 through the air inlet holes 33 of the battery case 30 passes through the air passages 15 of the cooling tubes 17, so that the cooling fins 16 can be cooled by the air passing through the air passages 15 of the cooling tubes 17 and also the cylindrical batteries 12 can be cooled. As a result, the air cooling of the cylindrical batteries 12 may be easily achieved.

Meanwhile, the insulation case 20 is fastened to the top, bottom, and peripheral portions of the battery module 10 in an insulating manner in order to insulate the battery module 10 from the battery case 30 made of conductive aluminum material.

For this purpose, as shown in FIGS. 2 to 4, the insulation case 20 includes an upper plate 22 configured to come into close contact with the top of the battery module 10, a lower plate 24 configured to come into close contact with the bottom of the battery module 10, and vertical connection bars 25 connected between the four corner positions of the upper plate 22 and the four corner positions of the lower plate 24.

In this case, the upper plate 22 is provided in a structure in which a plurality of upper heat dissipation holes 21 configured to communicate between the top plate 31 of the battery case 30 and the battery module 10 are formed through the upper plate 22. Accordingly, the upper plate 22 comes into close contact with the top of the battery module 10.

In addition, the lower plate 24 is provided in a structure in which a plurality of lower heat dissipation holes 23 configured to communicate between the lower plate portion 32 of the battery case 30 and the battery module 10 are formed through the lower plate 24. Accordingly, the lower plate 24 comes into close contact with the bottom of the battery module 10.

In the state in which the insulation case 20 is fastened to the battery module 10 provided as described above, the battery module 10 and the insulation case 20 may be inserted and fastened into the battery case 30 injection-molded with aluminum.

Accordingly, the insulation between the upper plate 31 of the battery case 30 and the battery module 10 may be achieved by the upper plate 22 of the insulation case 20. The heat generated in the battery module 10 may be conducted to the battery case 30 through the plurality of upper heat dissipation holes 21 formed in the upper plate 22. The heat conducted to the battery case 30 may be easily discharged to the outside.

In the same manner, the insulation between the lower plate portion 32 of the battery case 30 and the battery module 10 may be achieved by the lower plate 24 of the insulation case 20. The heat generated in the battery module 10 may be conducted to the battery case 30 through the plurality of lower heat dissipation holes 23 formed in the lower plate 24. The heat conducted to the battery case 30 may be easily discharged to the outside.

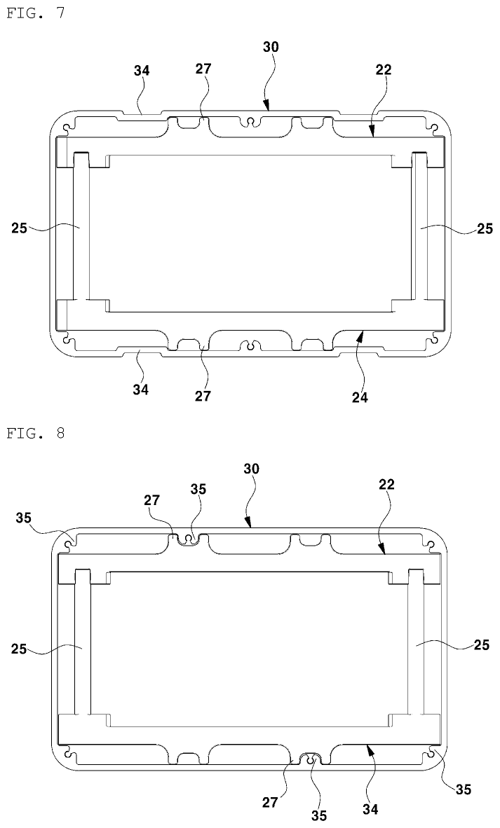

Meanwhile, referring to FIG. 7, two or more rail portions 34 formed to be concave inward are formed in each of the upper and lower plate portions 31 and 32 of the battery case 30. Slide protrusions 27 each configured to come into close slidable contact with one side of each of the rail portions 34 may be formed on the upper and lower plates 22 and 24 of the insulation case 20.

Accordingly, when the battery module 10 and the insulation case 20 are inserted and fastened into the battery case 30, the slide protrusions 27 formed on the upper and lower plates 22 and 24 of the insulation case 20 come into slidable contact with the rail portions 34 formed on the upper and lower plate portions 31 and 32 of the battery case 30 and are movable in a straight line. Accordingly, the battery module 10 and the insulation case 20 may be accurately inserted and fastened into the inside of the battery case 30 along a predetermined direction.

Alternatively, referring to FIG. 8, a plurality of heat dissipation fins 35 protrude from the inner surfaces of the upper and lower plates 31 and 32 of the battery case 30. Slide protrusions 27 configured to be slidably coupled to or come into close slidable contact with the heat dissipation fins 35 may be formed on the upper and lower plates 22 and 24.

Accordingly, when the battery module 10 and the insulation case 20 are inserted and fastened into the battery case 30, the slide protrusions 27 formed on the upper and lower plates 22 and 24 of the insulation case 20 come into slidable contact with the heat dissipation fins 35 formed on the upper and lower plates 31 and 32 of the battery case 30 and are movable in a straight line. Therefore, the battery module 10 and the insulation case may be accurately inserted and fastened into the inside of the battery case 30 along a predetermined direction.

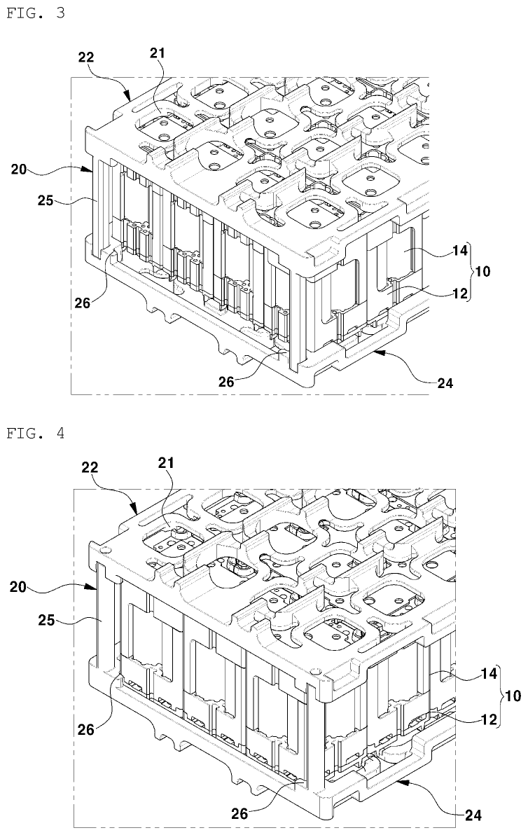

Referring to the accompanying FIGS. 3 to 6, right-angled stepped blocks 26 configured to accommodate and support battery modules 10 having different sizes are formed to protrude from at four corner positions on the top surface of the upper plate 22 of the insulation case 20 and four corner positions on the bottom surface of the lower plate 24 of the insulation case 20.

Therefore, the four corners of each of the battery modules having different sizes may each be supported in close contact with one side or the other side of each of the stepped blocks 26.

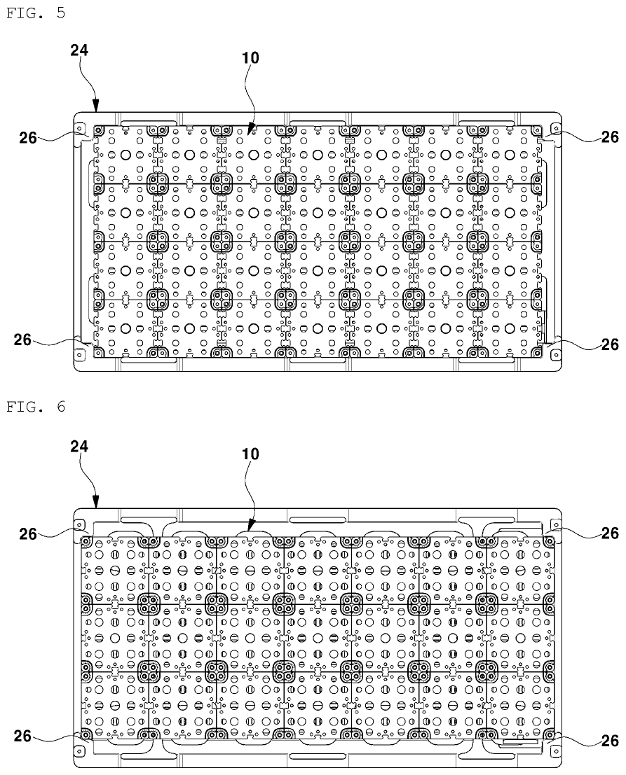

For example, as shown in FIGS. 3 and 5, in the case of the battery module 10 in which the overall length in the front-back directions is relatively short and the overall width in the left-right directions is relatively long, it may be supported in close contact with one surface of each of the stepped blocks 26 formed on the upper and lower plates 22 and 24. In contrast, as shown in FIGS. 4 and 6, in the case of the battery module 10 in which the overall length in the front-back directions is relatively long and the overall width in the left-right directions is relatively short, it may be supported in close contact with the other surface of each of the stepped blocks 26 formed on the upper and lower plates 22 and 24.

The four corners of each of the battery modules 10 having different sizes may be supported in close contact with one side or the other side of each of the stepped blocks 26 formed on the upper and lower plates 22 and 24 as described above, with the result that the battery modules 10 having different sizes may be stably fixed within the one insulation case 20.

Meanwhile, in the state in which the battery module 10 and the insulation case 20 are inserted and fastened into the inside of the battery case 30, a front cover 40 is mounted on the front of the battery case 30 while sealing the inside of the battery case 30.

Furthermore, a connector 41 configured to selectively charge and discharge the battery module 10 is mounted at a predetermined position on the front cover 40, and a handle 42 used for carrying is mounted on the outer surface of the front cover 40.

In this case, a battery control board 44 configured to control battery charging and discharging as well as a bus bar 43 conductively connected to the battery module 10 and configured to serve as a charging and discharging path is mounted in the front space of the battery case 30.

Preferably, the battery control board 44 is conductively connected to the bus bar 43, and is configured to control the discharging of battery power to the connector 41 or control the charging of charging power, coming from the connector 41, into the battery module 10.

The battery pack of the present invention configured as described above may be mounted on various types of auxiliary driving equipment such as a medical electric scooter, a medical electric wheelchair, etc.

Accordingly, power to be used to drive the auxiliary driving equipment may be discharged from the battery module 10 to the connector 41 through the bus bar 43 by the discharging control of the battery control board 44.

In this case, even when heat is generated in the battery module 10, it may be conducted to the battery case 30 through the plurality of upper heat dissipation holes 21 formed in the upper plate 22 and the plurality of lower heat dissipation holes 23 formed in the lower plate 24, and may be easily discharged out of the battery case 30.

Moreover, as the air flowing into the battery case 30 through the air inlet holes 33 of the battery case 30 passes through the air passages 15, the air cooling of the cylindrical batteries 12 may be easily achieved. Accordingly, it may be possible to maintain and improve the performance of the battery module.

As described above, the battery module 10 is covered with the insulation case 20 so that the battery module 10 covered with the insulation case 20 can be detachably inserted and fastened into the battery case 30 injection-molded with aluminum. Accordingly, the air cooling of the battery module may be performed, and the repair and maintenance of the battery module 10 as well as the charging and discharging of the battery module 10 may be easily performed. Therefore, the battery pack of the present invention may be conveniently carried, may be mounted on various types of auxiliary driving equipment such as a medical electric scooter, a medical electric wheelchair, etc. to enable charging and discharging, and may be conveniently used.

Through the above-described configuration, the present invention provides the following advantages:

First, the battery module is covered with the insulation case and, thus, can be detachably inserted and fastened into the battery case injection-molded with aluminum, so that the air cooling of the battery module can be achieved and the repair and maintenance of the battery module can be easily performed.

Second, the heat generated in the battery module is allowed to be discharged directly to the outside through the battery case made of aluminum, so that the heat dissipation effect of the battery pack can be maximized.

Third, the lithium battery pack can be mounted on various types of auxiliary driving equipment such as a medical electric scooter, a medical electric wheelchair, etc. to enable charging and discharging, so that it is possible to use the lithium battery pack conveniently while carrying the lithium battery pack.

What is claimed is:

1. A lithium battery pack for a wheelchair and medical auxiliary driving equipment, the lithium battery pack comprising:
a battery module configured such that a plurality of cylindrical batteries are arranged along horizontal and vertical directions therein;
an insulation case fastened to top, bottom, and peripheral portions of the battery module in an insulating manner;
a battery case injection-molded with aluminum so that the battery module and the insulation case fastened to the battery module can be detachably inserted and fastened thereinto;
a front cover mounted on a front of the battery case in a state in which the battery module and the insulation case are inserted and fastened into the battery case; and
a connector mounted at a predetermined position on the front cover to charge and discharge the battery module.

2. The lithium battery pack of claim 1, wherein:
the battery module includes a plurality of battery trays provided with a plurality of battery insertion portions, and a plurality of cylindrical batteries configured to be inserted and fastened into the battery insertion portions of the individual battery trays;
in a state in which the battery module is inserted and fastened into the battery case, the individual cylindrical batteries inserted into the battery insertion portions of the individual battery trays are spaced apart from each other while forming air passages; and
cooling fins are disposed in close contact between the individual cylindrical batteries, and cooling tubes each having an air passage are inserted to pass through the cooling fins.

3. The lithium battery pack of claim 2, wherein one or more air inlet holes configured to allow air to flow into the air passages are formed at predetermined positions in the battery case.

4. The lithium battery pack of claim 1, wherein the insulation case includes:
an upper plate provided in a structure in which a plurality of upper heat dissipation holes for communicating between an upper plate portion of the battery case and the battery module are formed therethrough, and configured to come into close contact with a top of the battery module;
a lower plate provided in a structure in which a plurality of lower heat dissipation holes for communicating between a lower plate portion of the battery case and the battery module are formed therethrough, and configured to come into close contact with a bottom of the battery module; and
vertical connection bars connected between four corner positions of the upper plate and four corner positions of the lower plate.

5. The lithium battery pack of claim 4, wherein right-angled stepped blocks configured to accommodate and support battery modules having different sizes protrude at four corner positions on a top surface of the upper plate and four corner positions on a bottom surface of the lower plate, so that four corners of the battery module are each supported in close contact with one side or the other side of each of the stepped blocks.

6. The lithium battery pack of claim 4, wherein two or more rail portions formed to be concave inward are formed on the upper and lower plate portions of the battery case, and slide protrusions each configured to come into close slidable contact with one side of each of the rail portions are formed on the upper and lower plates of the insulation case.

7. The lithium battery pack of claim 4, wherein a plurality of heat dissipation fins protrude from inner surfaces of the upper and lower plates of the battery case, and slide protrusions configured to be slidably coupled to or come into close slidable contact with the heat dissipation fins are formed on the upper and lower plates of the insulation case.

8. The lithium battery pack of claim 1, wherein the front cover is mounted with a handle used for carrying.

9. The lithium battery pack of claim 1, further comprising:
a bus bar mounted in a front space of the battery case while being conductively connected to the battery module; and
a battery control board conductively connected to the bus bar and configured to control discharging of battery power to the connector or control charging of charging power, coming from the connector, into the battery module.
